(19) United States
(12) Patent Application Publication
(10) Pub. No.: US 2015/0129560 A1
(43) Pub. Date: May 14, 2015

(54) PLASMA-MIG WELDING METHOD AND WELDING TORCH

(71) Applicant: HONDA MOTOR CO., LTD., Tokyo (JP)

(72) Inventors: Yusuke Muramatsu, Tochigi (JP); Katsuya Matsumoto, Tochigi (JP); Jun Kitagawa, Tochigi (JP); Keishi Setoda, Tochigi (JP)

(21) Appl. No.: 14/381,450

(22) PCT Filed: Feb. 18, 2013
(86) PCT No.: PCT/JP2013/053815

§ 371 Date: Aug. 27, 2014

(30) Foreign Application Priority Data
Feb. 29, 2012 (JP) 2012-044483

(51) Int. Cl. B23K 10/02; B23K 9/29; H05H 1/34; B23K 9/173

(52) U.S. Cl. CPC B23K 10/02; B23K 9/173; B23K 9/295; H05H 1/34
USPC 219/74; 219/121.53

(57) ABSTRACT

Provided are a plasma-MIG welding method and a welding torch that are capable of reducing spatter amount without relying on control of a MIG welding power supply. The plasma-MIG welding method employs a plasma-MIG welding device configured from: a plasma torch section that includes a plasma nozzle and a plasma electrode; and an MIG torch that includes an MIG tip and a welding wire. The plasma torch section and the MIG torch are arranged so as to face in different directions at a predetermined distance from each other. The plasma-MIG welding method is characterized in that a plasma arc is made to locally overlap with a tip end portion of the welding wire, and in a state in which melting of the welding wire is promoted, MIG welding is carried out without short-circuiting between a workpiece and a tip end of the welding wire which is a consumable electrode.

### TECHNICAL FIELD

The present invention relates to a technique for assisting a consumable electrode welding by plasma, in particular, relates to a plasma-MIG welding method and a welding torch.

### BACKGROUND ART

Conventionally, there has been known a MIG (Metal Inert Gas) welding method. As shown in FIG. 6, a conventional typical MIG torch includes a MIG tip 101, a welding wire 102 to be inserted into the MIG tip 101, and a shield nozzle 103. Then, for example, an arc (a MIG arc) 104 is generated by supplying power to the welding wire 102 which is a consumable electrode via the MIG tip 101 for power supplying, from a MIG welding power supply (not shown) which is a DC power source. At this time, a shield gas 105 such as argon is supplied to a space between the MIG tip 101 and the shield nozzle 103. As shown in FIG. 6, the MIG tip 101 and the shield nozzle 103 have a same central axis with each other (coaxial), and tip end sides thereof face a surface of a workpiece W. That is, the tip end side of the MIG tip 101 faces downward, and when the welding wire 102 to be a welding material melts, a droplet 106 falls from the tip end to the surface of the workpiece W substantially thereunder, and a molten pool 107 is generated on the surface of the workpiece W.

Further, there has been conventionally known a plasma-MIG welding method (for example, refer to Patent Document 1). As shown in FIG. 7, a conventional typical plasma-MIG torch includes a MIG tip 201 for supplying power to a welding wire 210 which is a consumable electrode, a plasma electrode 202, a plasma nozzle 203, and a shield nozzle 204. Here, the plasma electrode 202 which is a hollow electrode is made of a water-cooled conductive member, and is disposed outside the MIG tip 201. The plasma nozzle 203 is disposed outside the plasma electrode 202, and the shield nozzle 204 is disposed outside the plasma nozzle 203. Between the MIG tip 201 and the plasma electrode 202, a center gas 205 such as Ar or a mixed gas of Ar+CO₂ is supplied, and between the plasma electrode 202 and the plasma nozzle 203, a plasma gas (working gas) 206 is supplied, and further between the plasma nozzle 203 and the shield nozzle 204, a shield gas 207 such as Ar or a mixed gas of Ar+CO2 is supplied. Then, a MIG arc 208 is, for example, generated by supplying power to the welding wire 210 via the MIG tip 201 from the MIG welding power supply (not shown) which is the DC power source. Further, a plasma arc 209 is generated by supplying power to the plasma electrode 202 from a plasma welding power supply (not shown).

As shown in FIG. 7, the MIG tip 201, the welding wire 210, the plasma electrode 202, the plasma nozzle 203, and the shield nozzle 204 have the same central axis with one another (coaxial), and the tip end sides thereof face the surface of the workpiece W. That is, the tip end sides of the MIG tip 201, the plasma electrode 202, the plasma nozzle 203, and the shield nozzle 204 face downward, and when the welding wire 210 to be a welding material melts, a droplet falls to the surface of the workpiece W substantially thereunder. Further, since the MIG tip 201 and the plasma electrode 202 are coaxial, as shown in FIG. 7, the plasma arc 209 is generated so as to surround the MIG arc 208 and the welding wire 210 which is supplied via the MIG tip 201. Further, since the MIG tip 201 and the plasma electrode 202 are coaxial, it is necessary that a positive electrode of the MIG welding power supply (not shown) is connected to the MIG tip 201, while a positive electrode of the plasma welding power supply (not shown) is connected to the plasma electrode 202, so as not to cause arc repulsion. In addition, each negative electrode of the power supplies is connected to the workpiece W at this time.

### CITATION LIST

### Patent Literature

{Patent Document 1}

Japanese Patent Application Publication No. 2011-121057

### SUMMARY OF INVENTION

### Technical Problem

Generally, in MIG welding, spatter of a molten wire to a periphery thereof occurs. An amount of spatter in this case varies depending on a type of droplet transfer model. The transfer model of the droplet is, for example, differentiated in accordance with a magnitude of a welding current, and there have been known a spray transfer in a large current region of about 300 A or more, a short circuit transfer in a small current region of about 150 A or less, and a globular transfer in a middle current region therebetween.

A difference in the magnitude of the welding current is, for example, associated with a difference in thickness or material of a workpiece which is assumed to be a welding object. Here, for example, it is assumed that materials of the workpieces are the same and thicknesses thereof are different from each other. For example, as workpieces to be used for boats and ships, nuclear power plants, bridges, buildings, or the like, the workpieces of plate thickness about 20 to 30 mm are assumed. These are referred to as workpieces in a thick plate region. Further, for example, as workpieces to be used for vehicle bodies such as an automobile, the workpieces of plate thickness about 2 mm or the workpieces of plate thickness about 4 mm in an overlapped state of several pieces are assumed. These are referred to as workpieces in a thin plate region.

During MIG welding in the thin plate region, a current region of about 200 A or less is assumed. The transfer model of the droplet in this current region is generally the short circuit transfer. When the transfer model of the droplet is the short circuit transfer, there has been proposed and carried out a devisal or the like in which the amount of spatter is reduced by control of a conductive waveform of the MIG welding power supply, for example, by control of adjusting the welding current while detecting timings before and after a short circuit by a welding voltage. However, there is a limitation in an effect of reducing the amount of spatter by control of the MIG welding power supply.

Therefore, an object of the present invention is to solve the above problems and to provide a plasma-MIG welding method and a welding torch which can reduce the amount of spatter without relying on control of the MIG welding power supply.

### Solution to Problem

In order to solve the above problems, inventors of the present invention have conducted various studies on relationships between the amount of spatter and the transfer model of the droplet in plasma-MIG welding. As a result, it has been found that it is possible to reduce spatter by allowing the droplet to fall from the tip end of the welding wire without the short circuit transfer by heating the welding wire by plasma, while assisting melting of the welding wire which is supplied with power by plasma in the MIG torch, with use of the welding torch in which the MIG torch and a plasma torch section are separated to have different axes from each other.

To solve the above problems, a plasma-MIG welding method according to the present invention is a method with use of a plasma-MIG welding device which is configured such that a plasma torch section including a plasma nozzle and a plasma electrode, and a MIG torch including a MIG tip and a welding wire are arranged so as to face in different directions at a predetermined distance from each other, wherein a plasma arc is made to locally overlap with a tip end portion of the welding wire in order to carry out heating, and in a state in which melting of the welding wire is promoted, MIG welding is carried out without short-circuiting between an object to be welded and a tip end of the welding wire which is a consumable electrode.

In this way, melting of the welding wire, which is inserted through the MIG tip, is promoted by plasma in the MIG torch, and a short circuit does not occur due to aerial spraying of the droplet which is generated by melting of the welding wire. Therefore, even if a low MIG welding current, at which the transfer model of the droplet is the short circuit transfer, is actually supplied, an effect is obtained as if a MIG welding current of a magnitude, at which the transfer model of the droplet is a drop transfer, is supplied, with respect to the tip end portion of the welding wire. Consequently, it is possible to reduce the amount of spatter without relying on control of the MIG welding power supply.

Further, the plasma-MIG welding method according to the present invention is preferably a method wherein a tip end portion, which is a part of a projection portion of the welding wire projected from a tip end of a nozzle for a shield gas to be supplied to the MIG torch, is heated.

In this way, since the projection portion of the welding wire projected from the tip end is not wholly heated, it is possible to change a size of the droplet generated by melting of the welding wire to a desirable size by appropriately changing a part to be heated. Therefore, by managing a length of the part to be heated, out of the projection portion of the welding wire, a droplet transfer can be stabilized.

Further, the plasma-MIG welding method according to the present invention is preferably a method wherein in the projection portion of the welding wire, the tip end portion of a length of 3 to 10 times a diameter of the welding wire is heated. In this way, since the size of the droplet generated by melting of the welding wire becomes small, the droplet transfer is stabilized. Consequently, it is possible to effectively reduce the amount of spatter.

Further, the plasma-MIG welding method according to the present invention is preferably a method wherein in the state in which melting of the welding wire is promoted, the tip end portion is heated so as to generate a droplet of a diameter of 1 to 2 times a diameter of the welding wire. In this way, since the size of the droplet becomes small by about half from one third compared to a case of a globular transfer, the droplet transfer is stabilized, and the amount of spatter can be effectively reduced.

Further, a welding torch according to the present invention is a welding torch of the plasma-MIG welding device which is used in any one of the plasma-MIG welding methods which are described above, wherein the plasma torch section including the plasma nozzle and the plasma electrode, and the MIG torch including the MIG tip and the welding wire are arranged so as to face in different directions at the predetermined distance from each other, and wherein the plasma torch section and the MIG torch are arranged at positions in which the plasma arc can locally overlap with the tip end portion of the welding wire, and a central axis line of the plasma torch section and a central axis line of the MIG torch intersect at an acute angle.

With this configuration, in the welding torch, since the plasma arc can locally overlap with the tip end portion of the welding wire in order to carry out heating, MIG welding can be carried out without short-circuiting between the object to be welded and the tip end of the welding wire, in the state in which melting of the welding wire is promoted.

### Advantageous Effects of Invention

According to the present invention, it is possible to reduce the amount of spatter without relying on control of the MIG welding power supply.

### BRIEF DESCRIPTION OF DRAWINGS

FIG. 1A is a schematic diagram of a wire tip when using a plasma-MIG welding method according to the present invention, and shows a state of the wire tip at a start of MIG welding;

FIG. 1B is a schematic diagram of the wire tip when using the plasma-MIG welding method according to the present invention, and shows a state of the wire tip at a start of heating by plasma;

FIG. 1C is a schematic diagram of the wire tip when using the plasma-MIG welding method according to the present invention, and shows a state of the wire tip after stabilization of a plasma arc;

FIG. 1D is a schematic diagram of the wire tip when using the plasma-MIG welding method according to the present invention, and shows a state in which a molten metal is separated from the wire tip;

FIG. 2A is a schematic diagram of a welding torch, and shows a MIG torch and a plasma torch section housed in the welding torch;

FIG. 2B is a schematic diagram of the welding torch, and shows a design example of arrangement parameters for identifying a direction of a nozzle, and a relative position of the plasma torch section with respect to the MIG torch;

FIG. 3 is a schematic diagram showing a configuration of a welding system for carrying out the plasma-MIG welding method according to the present invention;

FIG. 4A is an explanatory diagram of a procedure of a penetration welding method according to a comparative example, and shows a hole-digging process;

FIG. 4B is an explanatory diagram of the procedure of the penetration welding method according to the comparative example, and shows a hole-digging completion and an extinguishment of the plasma arc;

FIG. 4C is an explanatory diagram of the procedure of the penetration welding method according to the comparative example, and shows a hole-filling process;

FIG. 4D is an explanatory diagram of the procedure of the penetration welding method according to the comparative example, and shows time variations of a plasma welding current and a MIG welding current during a penetration welding;

FIG. 5A is an explanatory diagram of a procedure when a plasma-MIG welding method according to the present invention is applied to the penetration welding, and shows a hole-digging process;

FIG. 5B is an explanatory diagram of the procedure when the plasma-MIG welding method according to the present invention is applied to the penetration welding, and shows a hole-filling process;

FIG. 5C is an explanatory diagram of the procedure when the plasma-MIG welding method according to the present invention is applied to the penetration welding, and shows time variations of the plasma welding current and the MIG welding current during the penetration welding;

FIG. 6 is a schematic diagram of a configuration of a MIG torch in the prior art; and

FIG. 7 is a schematic diagram of a configuration of a plasma-MIG torch in the prior art.

### DESCRIPTION OF EMBODIMENTS

An embodiment for carrying out the present invention (referred to as an implementation embodiment) will be described in detail with reference to the drawings.

### [1. Overview of Plasma-MIG Welding Method]

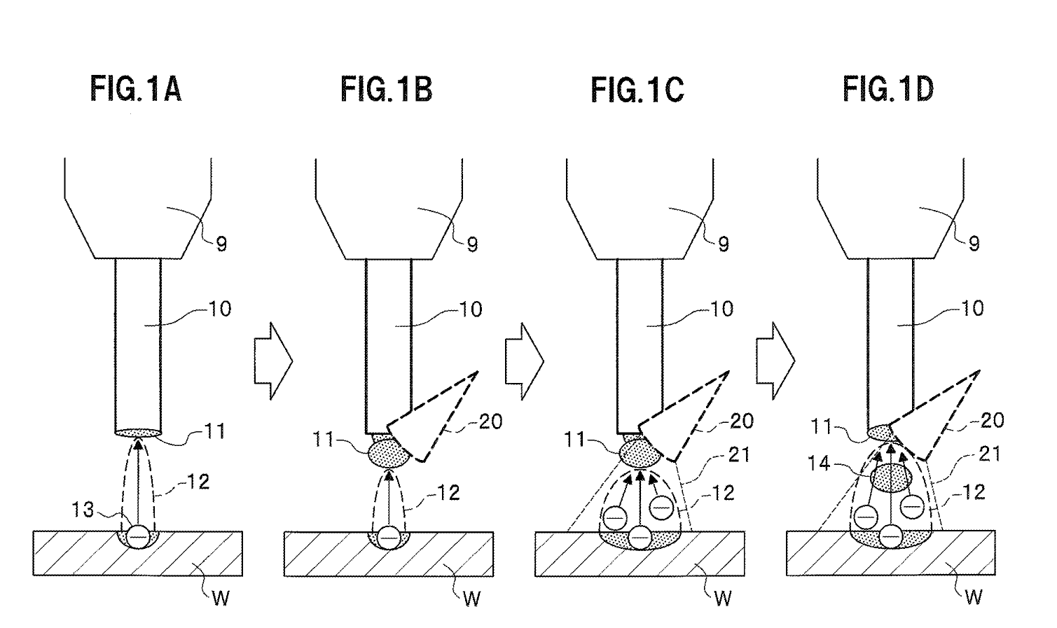

Here, an overview of a plasma-MIG welding method according to the embodiment of the present invention will be described with reference to FIGS. 1A, 1B, 1C, and 1D. To a MIG torch 9 shown in FIG. 1A, a positive electrode of a MIG welding power supply (not shown) is connected, and a negative electrode of the power supply is connected to a workpiece W which is a base material. When starting MIG welding, a welding wire (hereinafter, referred to as simply a wire 10) fed from the MIG torch 9 is heated at a tip end 11 thereof by supplying power thereto, and a MIG arc 12 is generated between the workpiece W and the tip end 11, and further an electron carries a charge 13 between the workpiece W and an electrode (the wire 10). In general, spatter occurs when a wire having a charge is brought into contact with (is short-circuited to) a molten pool.

In the plasma-MIG welding method according to the present embodiment, as shown in FIG. 1B, melting of the wire 10 which is supplied with power in the MIG torch 9 is assisted by a plasma 20 from a plasma torch section (not shown) in order to heat the wire 10. Thus, melting of the tip end 11 of the wire 10 is promoted.

In the plasma-MIG welding method according to the present embodiment, as shown in FIG. 1C, since the plasma 20 enters between the workpiece W and the wire 10, the MIG arc 12 is surrounded by a plasma arc 21, and the MIG arc 12 is stabilized.

In the plasma-MIG welding method according to the present embodiment, as shown in FIG. 1D, between the workpiece W and the wire 10, a droplet 14 is separated in the air (aerial spraying), and melts into the workpiece W. At this time, since the droplet 14 is separated from a wire tip 11 in the air, there is no possibility that the droplet 14 has a charge. In a conventional short circuit transfer, spatter occurs because the wire having the charge is brought into contact with (is short-circuited to) the molten pool, however, according to the plasma-MIG welding method of the present embodiment, there is an assist effect for a wire tip melting by a plasma. Therefore, even if a MIG welding current of a magnitude, at which a transfer mode of a droplet is a general short circuit transfer, is supplied, the transfer mode of the droplet 14 does not become a short circuit transfer but becomes a drop transfer actually. Thus, spatter can be reduced. Further, the droplet 14, which does not have a charge, has good wettability and can be well adapted to the molten pool.

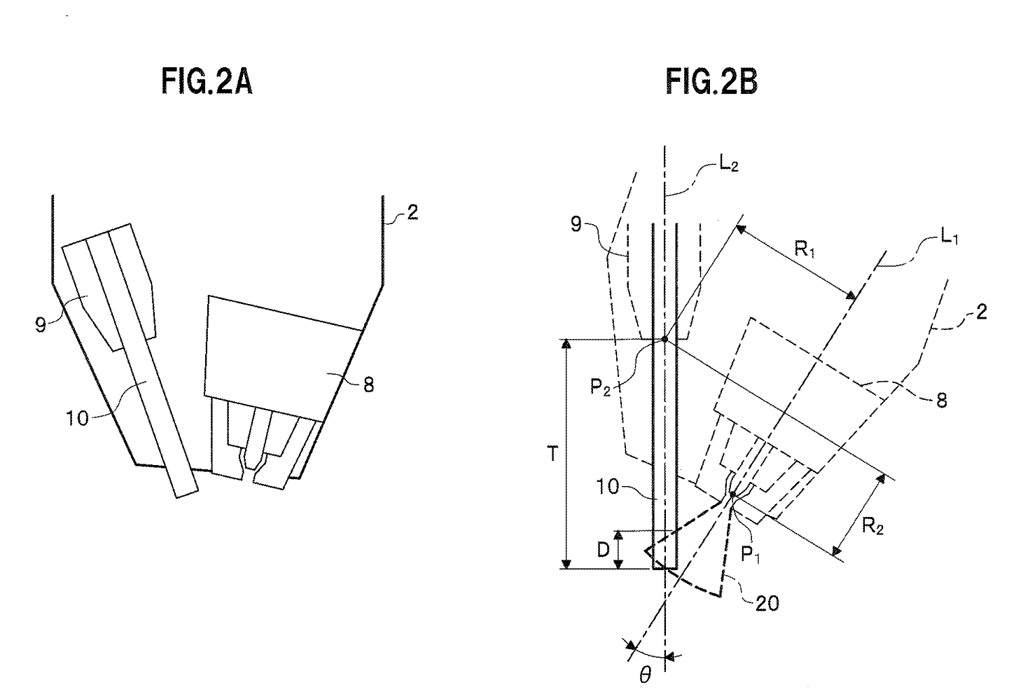

The plasma-MIG welding method according to the present embodiment can be implemented with use of a plasma-MIG welding device including the MIG torch 9 and a torch for generating a plasma arc. Schematic diagrams of a welding torch 2 included in this plasma-MIG welding device are shown in FIGS. 2A and 2B.

The welding torch 2 shown in FIG. 2A has a function of housing a plasma torch section 8 and the MIG torch 9, and a function as a shield nozzle for a shield gas to be supplied to the MIG torch 9. In the welding torch 2, the plasma torch section 8 and the MIG torch 9 are arranged so as to face in different directions at a predetermined distance from each other, and a central axis line of the plasma torch section 8 and a central axis line of the MIG torch 9 intersect at an acute angle (for example, 15 degrees). The plasma torch section 8 faces the lower left in FIG. 2A, and a direction of the MIG torch 9 and a feed direction of the wire 10 which is inserted therein are toward the lower right in FIG. 2A.

The plasma torch section 8 is made of a general plasma torch to be used in plasma arc welding, and includes a plasma nozzle and a plasma electrode, for example. The MIG torch 9 is made of a general MIG torch to be used in MIG welding, and includes a MIG tip and the wire 10, for example. In FIG. 2A, the MIG tip 9 is shown with the wire 10 inside a tip and the tip in a simplified manner.

For example, FIG. 2B shows a design example of arrangement parameters for identifying a direction of a nozzle, and a relative position of the plasma torch section 8 with respect to the MIG torch 9. Here, a coordinate space is assumed such that a tip end center of the plasma electrode of the plasma torch section 8 is a coordinate origin, and a XY plane (Z=0) as a vertical plane is on a paper surface, and further a Z-axis is in a depth direction perpendicular to the paper surface. However, in the welding torch 2 in FIG. 2B, the relative position in the XY plane (Z=0) will be, for example, described in order to simplify the description. Incidentally, in FIG. 2B, the welding torch 2 is shown by dashed lines rotated by a predetermined angle to the right (in the clockwise direction) of the welding torch 2 shown in FIG. 2A.

In FIG. 2B, as an example, the direction of the plasma torch section 8 is identified by an axis line L₁ of the nozzle of the plasma torch section 8. The direction of MIG torch 9 is identified by an axis line L₂ of a feed guide of the wire 10 in the MIG tip of the MIG torch 9. The axis line L₁ and the axis line L₂ intersect at an angle θ in FIG. 2B. The position of the plasma torch section 8 is identified by a position P₁ of the tip end of the plasma electrode. The position of the MIG torch 9 is identified by a position P₂ of a tip end of the MIG tip of the MIG torch 9. In the axis line L₁, a direction to the position P₁ from a main body of the plasma torch section 8 shows a direction of the nozzle of the plasma torch section 8. In the axis line L₂, a direction to the position P₂ from a main body of the MIG torch 9 shows a direction of the nozzle of the MIG torch 9. The direction of the nozzle of the plasma torch section 8 is inclined by the angle θ from the direction of the nozzle of the MIG torch 9.

In this case, in a direction of the axis line L₁, a relative distance of the plasma torch section 8 with respect to the MIG torch 9 is R₂, and in a direction perpendicular to the axis line L₁, a relative distance of the plasma torch section 8 with respect to the MIG torch 9 is R₁. Therefore, for example, if it is assumed that the direction of the axis line L₁ is an X direction, and the direction perpendicular to the axis line L₁ is a Y direction, the relative position of the plasma torch section 8 with respect to the MIG torch 9 can be determined by shift amounts (R1, R2) in the X direction and the Y direction. Values of these parameters are not particularly limited, if the plasma torch section 8 is disposed with respect to the MIG torch 9 so that the droplet can transfer without short-circuiting by heating the tip end portion of the wire 10 by the plasma 20 from the plasma torch section 8.

A length of a projection portion of the wire 10 projected from the tip end of the nozzle for the shield gas to be supplied to the MIG torch is denoted by T as shown in FIG. 2B. Further, a length of a tip end portion which is a part of the projection portion is denoted by D as shown in FIG. 2B. The plasma 20 aims at the tip end portion of length D to heat the wire 10. When transferring the droplet so as not to short-circuit, the length D of the tip end portion which is the part of the projection portion of the wire 10 is preferably 3 to 10 times a diameter of the wire. In this way, since a size of the droplet generated by the wire 10 being melted is small, the droplet transfer is stabilized. For example, if a diameter of the wire is 1 mm, the length D can be in a range of 3 to 10 mm.

Further, when transferring the droplet so as not to short-circuit, it is preferable that the tip end portion is heated so that the diameter of the droplet is 1 to 2 times the diameter of the wire, the droplet being generated by promoting melting of the wire 10 by the plasma, the wire 10 being supplied with power, because an amount of spatter is reduced. For example, if the diameter of the wire is 1 mm, the size of the droplet can be in a range of 1 to 2 mm. Note that, in a case of a globular transfer, if the diameter of the wire is 1 mm, the size of the droplet becomes 3 to 4 mm or more, and the amount of spatter is increased.

### [2. Configuration of Welding System]

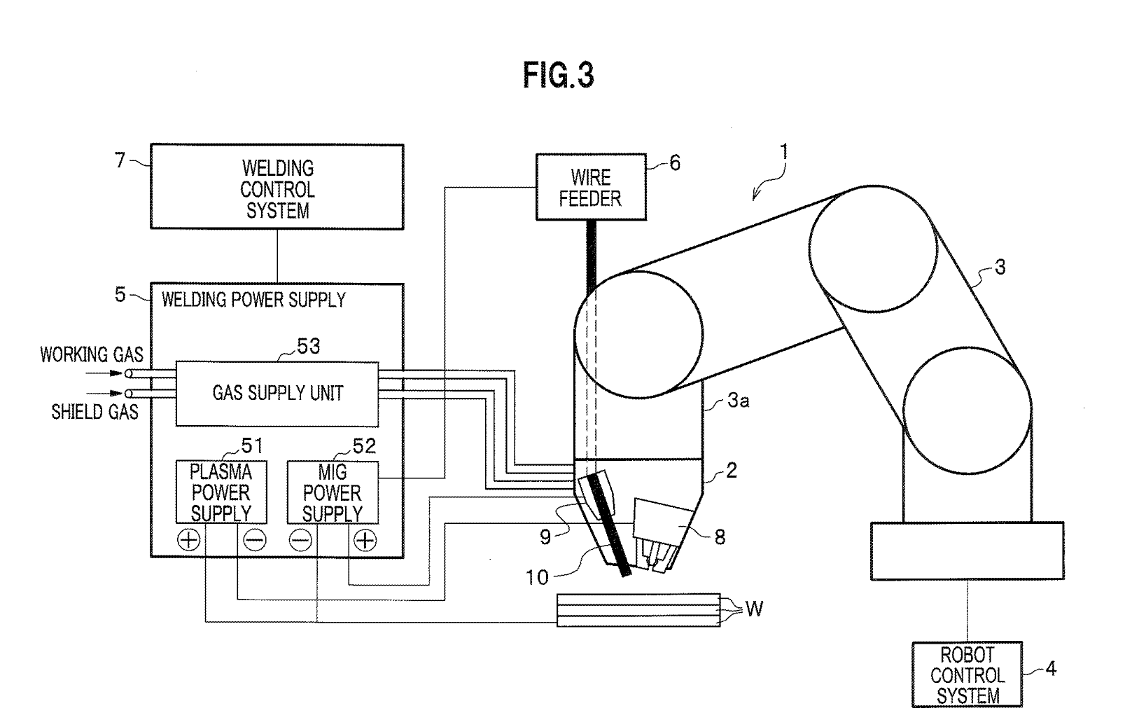

Here, a configuration of a welding system for carrying out the plasma-MIG welding method according to the present invention will be described with reference to FIG. 3. A welding system 1 is a robot arc welding system for carrying out a penetration welding of a plurality of workpieces W which are overlapped. A penetration welding method includes a step (hereinafter, referred to as a hole-digging process P1) for forming a through-hole, and a step (hereinafter, referred to as a hole-filling process P2) for filling the wire in the through-hole after the hole-digging process P1. The plasma-MIG welding method according to the present invention is assumed to be carried out in the hole-filling process P2.

Since the penetration welding method is assumed that a hole is dug in the workpiece to form a through-hole, and is immediately filled, the through-hole immediately turns to the hole. Therefore, the through-hole and the hole are distinguished from each other in the following. A state before filling after penetration is referred to as the through-hole. A state when digging the workpiece before penetration or a state when filling the through-hole after penetration is referred to as a hole. In the through-hole which is formed on the workpiece by penetration welding, a diameter of an upper end opening thereof, a diameter of a lower end opening thereof, and a diameter in the middle between the both ends are usually different from one another. Therefore, a diameter of an upper opening of the through-hole is referred to as an upper through-hole diameter, and a diameter of a lower opening of the through-hole is referred to as a lower through-hole diameter.

As shown in FIG. 3, the welding system 1 mainly includes the welding torch 2, a robot 3, a robot control system 4, a welding power supply 5, a wire feeder 6, and a welding control system 7. In addition, the welding system 1 includes a working gas cylinder, a shield gas cylinder, a gas flow controller, a remote controller, and the like, although these are not shown. In FIG. 3, a cross-section of the workpiece in a case in which three pieces of plate-like workpiece W are overlapped is shown as an example. Further, here, the description will be made on an assumption that there is no gap between the workpieces.

Incidentally, the robot control system 4 and the welding control system 7 respectively include, for example, a CPU (Central Processing Unit), a ROM (Read Only Memory), a RAM (Random Access Memory), a HDD (Hard Disk Drive), an input and output interface, and the like.

The welding torch 2 includes the plasma torch section 8 and the MIG torch 9. The plasma torch section 8 is a torch which is used to assist MIG welding in the hole-filling process P2. Further, the plasma torch section 8 is used to form the through-hole penetrating the plurality of workpieces W in the hole-digging process P1. The plasma torch section 8 is formed with the plasma nozzle and the plasma electrode for carrying out plasma arc welding, and the shield gas and a working gas such as argon are supplied. The plasma torch section 8 generates a pilot arc between a water-cooled constraint nozzle (plasma nozzle) and a tungsten electrode as the plasma electrode, and plasmatizes the working gas by heat of the pilot arc, to eject the plasmatized gas, and thus generates the plasma arc between the workpiece and the plasma torch section 8. As the shield gas, commonly used MAG gas (Ar+CO₂ gas mixture) or the like is supplied.

The MIG torch 9 is a torch for carrying out MIG welding. The MIG torch 9 includes the tip (MIG tip) which is housed in the MIG torch 9 for supplying power to the wire 10 as a consumable electrode, and the wire 10 which is inserted through a center of the tip. The MIG torch 9 is used in the hole-filling process P2, and fills the through-hole, to fuse the plurality of workpieces W which are overlapped. In the MIG torch 9, the wire 10 as the consumable electrode is fed from the wire feeder 6 to the center of the tip, and the shield gas (Ar+CO₂) is supplied around the wire 10.

The robot 3 is, for example, a multi-axis articulated welding robot, and the welding torch 2 is attached to an arm 3a on a tip end side thereof. The robot 3 is able to move the welding torch 2 by moving each joint by a motor. The robot control system 4 is connected to the robot 3, and is designed to control a posture and an operation of the robot 3 in accordance with a command which is stored in advance, or an input command of a welding path or the like.

The welding power supply 5 is designed to supply power for arc welding to the welding torch 2. Here, as shown in FIG. 3, the welding power supply 5 mainly includes a plasma power supply 51, a MIG power supply 52, and a gas supply unit 53. In addition, the welding power supply 5 includes a voltage and current detector, a control circuit necessary for MIG welding, and the like, although these are not shown.

The plasma power supply 51 supplies power to the plasma torch section 8 in the hole-digging process P1 and the hole-filling process P2. A negative electrode of the plasma power supply 51 is electrically connected to the tungsten electrode of the plasma torch section 8, and a positive electrode of the plasma power supply 51 is electrically connected to the workpiece W. Output characteristics of the plasma power supply 51 is generally a constant current characteristics, and thus an arc current after arc stabilization is maintained at a constant value. By this constant current control, an arc length can be estimated from a measured arc voltage.

The MIG power supply 52 supplies power to the MIG torch 9 in the hole-filling process P2 (during MIG welding). The positive electrode of the MIG power supply 52 is electrically connected to the wire 10 (consumable electrode) via the MIG tip of the MIG torch 9, and the negative electrode of the MIG power supply 52 is electrically connected to the workpiece W. Output characteristics of the MIG power supply 52 is a constant voltage characteristics, and thus the arc length after arc stabilization is maintained at a constant value.

The gas supply unit 53 supplies the shield gas for welding to the welding torch 2 from a gas cylinder which is not shown. Further, the gas supply unit 53 supplies the working gas for forming the plasma to the welding torch 2 from a gas cylinder which is not shown. The gas supply unit 53 adjusts flow rates of the shield gas and the working gas which flow therein at predetermined pressures by on-off valves (not shown) in accordance with instruction signals from the welding control system 7. It is preferable that the flow rate of the plasma gas is, for example, 3 l/min or less in the hole-filling process P2 (during MIG welding), so that the plasma arc does not become unstable.

The wire feeder 6 is connected to the MIG power supply 52. The wire feeder 6 feeds the wire, which is sent out from a wire housing unit (not shown) via a feed path, to the MIG torch 9 in the hole-filling process P2 (during MIG welding).

The welding control system 7 controls the welding power supply 5, by carrying out a process in the hole-digging process P1 and a process in the hole-filling process P2. By driving the welding power supply 5 in the hole-digging process P1, the welding control system 7 forms the through-hole penetrating the plurality of workpieces W which are overlapped, by plasma arc welding. That is, the welding control system 7 drives the plasma power supply 51, the gas supply unit 53, and the plasma torch section 8.

By driving the welding power supply 5 in the hole-filling process P2, the welding control system 7 fills the wire in the through-hole by MIG welding. That is, the welding control system 7 drives the MIG power supply 52, the gas supply unit 53, and the MIG torch 9. At this time, the welding control system 7 continues to drive the plasma torch section 8 and the plasma power supply 51, which have been used for digging in the hole-digging process P1. Thus, the welding control system 7 irradiates the plasma arc from the plasma arc section 8 to the tip end of the wire 10 which is fed from the MIG torch 9, to promote melting of the tip end of the wire 10.

[3. Specific Examples of Effect when Plasma MIG Welding Method is Applied to Penetration Welding]

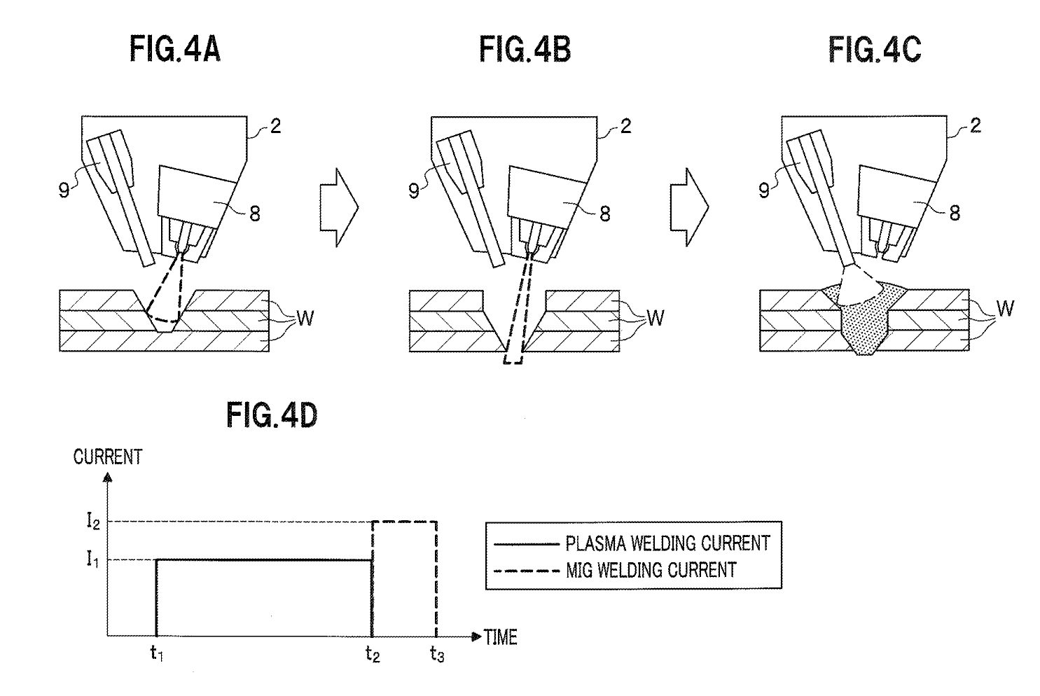

Here, in order to compare with the plasma MIG welding method of the present invention, a welding system is assumed as an example, the welding system carrying out a penetration welding in a procedure different from the process in the hole-digging process P1 and the process in the hole-filling process P2, which are described above in the welding system 1. The procedure of the penetration welding in the welding system of this comparative example will be described with references to FIGS. 4A, 4B, 4C, and 4D. Note that, components the same as those of the welding system 1 shown in FIG. 3 are denoted by the same reference numerals, and the description thereof will be appropriately omitted.

### <3-1. Comparative Examples of Penetration Welding Method>

In the hole-digging process P1, as shown in FIG. 4A, by use of the plasma torch section 8 in the welding torch 2, the welding system of the comparative example digs a hole in the workpiece W by plasma arc welding. As shown in FIG. 4B, when a desired through-hole is formed and a hole-digging is completed, the plasma arc is extinguished. And, as shown in FIG. 4C, a hole-filling is carried out by MIG welding. An example of time variations of a plasma welding current and the MIG welding current in this case is shown in FIG. 4D.

In a graph in FIG. 4D, a horizontal axis represents the time, and a vertical axis represents the welding current. Further, a solid line shows the plasma welding current, and a dashed line shows the MIG welding current in the graph. The welding system of the comparative example starts the hole-digging process P1 at a predetermined current value I₁ (for example, 100 A) of the plasma welding current at time t₁. Upon completion of the hole-digging process P1 at time t₂, the welding system of the comparative example reduces the plasma welding current to 0 A, to extinguish the plasma arc. On the other hand, the hole-filling process P2 is started at a predetermined current value I₂ (for example, 150 A) of the MIG welding current at time t₂. And, upon completion of the hole-filling process P2 at time t₃, the welding system of the comparative example reduces the MIG welding current to 0 A, to extinguish the MIG arc.

### <3-2. Working Example of Penetration Welding Method>

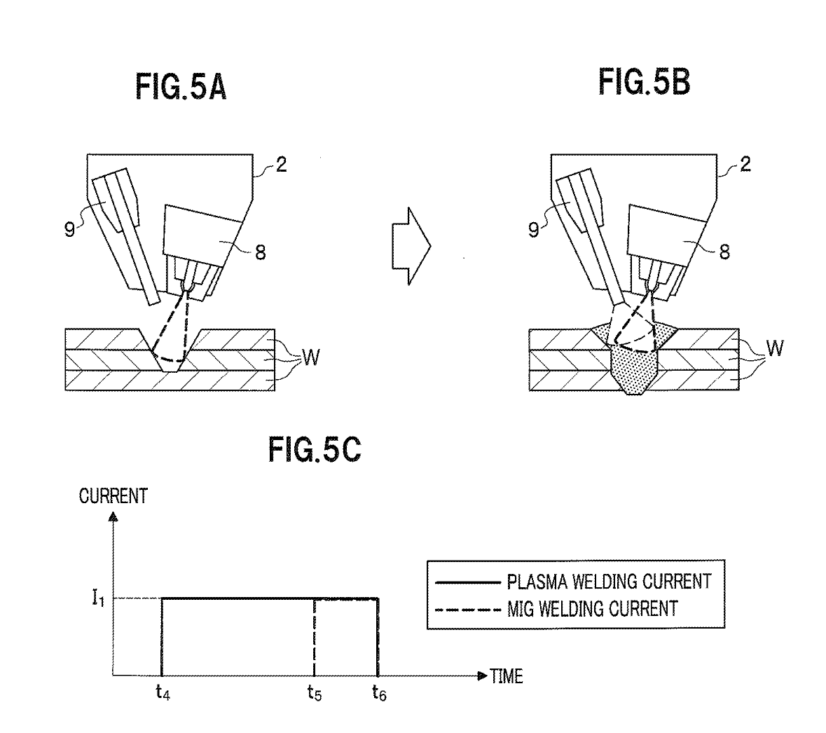

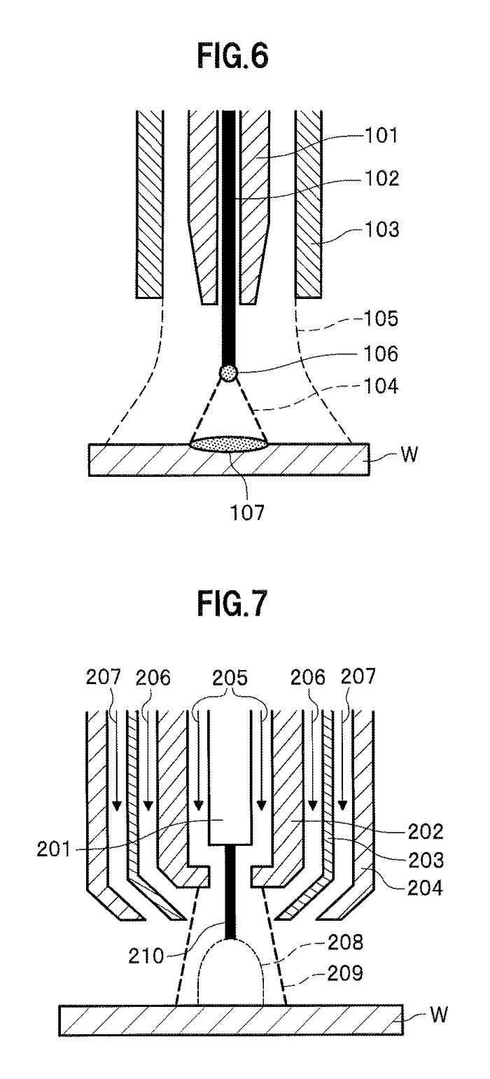

Next, a procedure of the penetration welding method in the welding system 1 for implementing the plasma-MIG welding method of the present invention will be described with references to FIGS. 5A, 5B, and 5C.

In the hole-digging process P1, as shown in FIG. 5A, by use of the plasma torch section 8 in the welding torch 2, the welding system 1 digs a hole in the workpiece W by plasma arc welding. When the desired through-hole is formed and the hole-digging is completed, the hole-filling is carried out without extinguishing the plasma arc, as shown in FIG. 5B. At this time, as shown in FIGS. 1B, 1C, and 1D, the tip end 11 of the wire 10 is selectively heated to be melted by the plasma 20. An example of the time variations of the plasma welding current and the MIG welding current in this case is shown in FIG. 5C.

The horizontal axis, the vertical axis, the solid line, and the dashed line of a graph in FIG. 5C shows the same as those of the graph in FIG. 4D. Note that, a predetermined current value I₁ in FIG. 5C is different from the predetermined current value I₁ in FIG. 4D, and times t₄, t₅, and t₆ in FIG. 5C are different from times t₁, t₂, and t₃ in FIG. 4D.

The welding system 1 starts the hole-digging process P1 at the predetermined current value I₁ (for example, 100 A) of the plasma welding current at time t₄. Even after completion of the hole-digging process at time t₅, the welding system 1 maintains the plasma welding current at the predetermined current value I₁. Further, at this time t₅, the hole-filling process P2 is started at the predetermined current value I₁ (for example, 100 A) of the MIG welding current. And, upon completion of the hole-filling process P2 at time t₆, the welding system 1 reduces the MIG welding current and the plasma welding current to 0 A, to extinguish the MIG arc and the plasma arc, respectively.

Incidentally, if the predetermined current value I1 in FIG. 5C is the same (for example, 100 A) as the predetermined current value I1 in FIG. 4D, a period (for example, 2 sec) of time t4 to t5 and a period (for example, 0.6 sec) of time t5 to t6 in FIG. 5C are respectively equal to a period (for example, 2 sec) of time t1 to t2 and a period (for example, 0.6 sec) of time t2 to t3 in FIG. 4D. According to the welding system 1 in a working example for carrying out the penetration welding method, since MIG welding is assisted by plasma in the hole-filling process P2, it is possible to reduce the MIG welding current compared to the comparative example, thereby obtaining an effect of reducing spatter.

As described above, by promoting melting of the wire 10 of the MIG torch 9 by plasma, the plasma-MIG welding method according to the embodiment of the present invention aerially sprays the droplet, which is generated by melting of the wire 10, without short-circuiting. Therefore, even if a low MIG welding current, at which the transfer model of the droplet is usually the short circuit transfer, is actually supplied, the transfer model of the droplet can be the drop transfer. Therefore, the amount of spatter can be reduced without relying on control of the MIG welding power supply.

Hereinabove, a preferred embodiment of the plasma-MIG welding method of the present invention has been described, but the present invention is not limited to the embodiment described above. The plasma-MIG welding method is, for example, applied to the penetration welding method, but it is not necessary that the workpiece has an open through-hole. That is, the plasma-MIG welding method of the present invention is not limited to an application to the penetration welding, and even in a case of a simple build-up, spatter can be reduced by plasma assistance during MIG welding.

Since the plasma-MIG welding method of the present invention can reduce spatter without relying on control of the MIG welding power supply, the MIG welding power supply may be a DC power supply or a pulse power supply. Further, the plasma-MIG welding method of the present invention may be applied to MAG welding.

### WORKING EXAMPLES

As an effect of the plasma-MIG welding method according to the present invention, in order to make sure that the droplet can be aerially sprayed to be the drop transfer without short-circuiting by heating the MIG welding wire by plasma, the following Experiment 1 and Experiment 2 have been carried out while the plasma torch section 8 and the MIG torch 9 are arranged so as to face in different directions at a predetermined distance from each other. Common conditions for each Experiment are as follows. The MIG welding current (also referred to as simply the MIG current) is set to a constant value (150 A). The diameter of the wire is set to 1 mm.

### Experiment 1

By increasing or decreasing the plasma welding current while the MIG welding current is set to the constant value, the amount of spatter has been measured without changing the other conditions. A list of measurement conditions and measurement results in this case is shown in Table 1. Note that, details will be described later.

### Experiment 2

By increasing or decreasing a projection length T (see FIG. 2B) of the wire 10 while the MIG welding current is set to the constant value, the amount of spatter has been measured without changing the other conditions. A list of measurement conditions and measurement results in this case is shown in Table 1. Note that, details will be described later.

TABLE 1

| | | plasma | MIG | projection | short | | MIG | droplet | MIG |
|---|---|---|---|---|---|---|---|---|---|
| | | current | current | length | circuit | drop | arc | size | spatter |
| No. | | (A) | (A) | T (mm) | count | count | state | (mm) | (g/point) |
| 1 | Comparative Example 1 | 0 | 150 | 20 | 20 | 0 | stable | 1.2 | 0.104 |
| 2 | Comparative Example 2 | 100 | 150 | 20 | 16 | 0 | stable | 1.4 | 0.070 |
| 3 | Working Example 1 | 125 | 150 | 20 | 0 | 10 | stable | 1.4 | 0.011 |
| 4 | Working Example 2 | 150 | 150 | 20 | 0 | 12 | stable | 1.4 | 0.005 |
| 5 | Working Example 3 | 175 | 150 | 20 | 0 | 11 | stable | 1.5 | 0.009 |
| 6 | Comparative Example 3 | 200 | 150 | 20 | 0 | 9 | unstable | 2.1 | 0.053 |
| 7 | Comparative Example 4 | 150 | 150 | 15 | 17 | 0 | stable | 1.4 | 0.080 |
| 8 | Working Example 4 | 150 | 150 | 18 | 0 | 10 | stable | 1.4 | 0.009 |
| 9 | Working Example 2 | 150 | 150 | 20 | 0 | 12 | stable | 1.4 | 0.005 |
| 10 | Working Example 5 | 150 | 150 | 22 | 0 | 10 | stable | 1.6 | 0.010 |
| 11 | Comparative Example 5 | 150 | 150 | 25 | 0 | 7 | unstable | 2.6 | 0.060 |

In Table 1, plasma current indicates the plasma welding current. Further, projection length T indicates the length T shown in FIG. 2B.

In Table 1, short circuit count indicates the number of the short circuit transfers in the droplet transfer mode, and drop count indicates the number of the drop transfers. The number of droplet transfers has been counted by observing with a high-speed camera. Here, the drop transfer means a transfer mode of a molten wire, in which the droplet flies toward the workpiece to land thereon from an upper position spaced from the workpiece, without the molten wire coming into contact with the workpiece and without short-circuiting.

The ways of falling when the droplet flies toward the workpiece to land thereon include, for example, ways of falling in drops at various speeds. Note that, the way of falling in this case is different from that in the globular transfer, in which a large droplet is formed to be torn off by a necking force.

In Table 1, a fact that a MIG arc state is unstable corresponds to that an arc length is too long. Droplet size indicates a calculated average value of sizes of a plurality of droplets by observing with the high-speed camera. MIG spatter indicates a calculated average value of amounts of spatter which has occurred at one point when spatter has occurred. This has been calculated by obtaining a total weight by recovering spatter which has been spattered, and by dividing the total weight by a total number of welding points.

Results of Experiment 1 are shown in samples No. 1 to No. 6 in Table 1, and results of Experiment 2 are shown in samples No. 7 to No. 11. Note that, sample No. 4 and sample No. 9 show the same one (Working Example 2).

### Experiment 1

In Experiment 1, by changing the plasma welding current to 0, 100, 125, 150, 175, and 200 A while the MIG welding current is set to 150 A, the amount of spatter has been measured without changing the other conditions. Samples No. 1 to No. 6 in this case are defined as Comparative Example 1, Comparative Example 2, Working Example 1, Working Example 2, Working Example 3, and Comparative Example 3 in this order.

In Comparative Example 1, since the wire is not heated by plasma, the transfer mode of the droplet from the wire is a short circuit transfer mode. Therefore, spatter has occurred before and after a short circuit. In Comparative Example 2, since the wire is heated a little by plasma, and melting of the wire is insufficient, the transfer mode of the droplet from the wire is the short circuit transfer mode. Therefore, spatter has occurred before and after a short circuit.

In Working Examples 1 to 3, the wire is melted by heating of the wire by plasma, and the transfer mode of the droplet is the drop transfer mode. Therefore, spatter has been reduced. In Comparative Example 3, by excessive heating of the wire by plasma, the wire has been melted up to the upper side. Thus, the droplet grows excessively, and the size of the droplet has become larger than that of Working Examples 1 to 3. And, the arc has become unstable by excessive arc length.

### (Summary of Experiment 1)

In Experiment 1, it has been verified that under measurement conditions where the MIG welding current is 150 A and the projection length is 20 mm, when the plasma welding current is set to 125 to 175 A, the droplet can be aerially sprayed to be the drop transfer without short-circuiting, thereby reducing the amount of spatter. In particular, when the plasma welding current is set to 150 A, the amount of spatter per point could be most reduced.

### Experiment 2

In Experiment 2, by changing the projection length to 15, 18, 20, 22, and 25 mm while the MIG welding current is set to 150 A, the amount of spatter has been measured without changing the other conditions. Samples No. 7 to No. 11 in this case are defined as Comparative Example 4, Working Example 4, Working Example 2, Working Example 5, and Comparative Example 5 in this order.

In Comparative Example 4, since the wire is heated a little by plasma, and melting of the wire is insufficient, the transfer mode of the droplet from the wire is the short circuit transfer mode. Therefore, spatter has occurred before and after a short circuit. In Working Examples 4, 2, and 5, the wire is melted by heating of the wire by plasma, and the transfer mode of the droplet is the drop transfer mode. Therefore, spatter has been reduced. In Comparative Example 5, by excessive heating of the wire by plasma, the wire has been melted up to the upper side. Thus, the droplet grows excessively, and the size of the droplet has become larger than that of Working Examples 4, 2, and 5. And, the arc has become unstable by excessive arc length.

### (Summary of Experiment 2)

In Experiment 2, it has been verified that under measurement conditions where the MIG welding current is 150 A and the plasma welding current is 150 A, when the projection length is set to 18 to 22 mm, the droplet can be aerially sprayed to be the drop transfer without short-circuiting, thereby reducing the amount of spatter. In particular, when the projection length is set to 20 mm, the amount of spatter per point could be most reduced.

### REFERENCE SIGNS LIST

1: welding system
2: welding torch
3: robot
3a: arm
4: robot control system
5: welding power supply
6: wire feeder
7: welding control system
8: plasma torch section
9: MIG torch
10: wire
11: wire tip end portion
12: MIG arc
13: charge
14: droplet
20: plasma
21: plasma arc
51: plasma power supply
52: MIG power supply
53: gas supply unit
W: workpiece

1. A plasma-MIG welding method with use of a plasma-MIG welding device which is configured such that a plasma torch section including a plasma nozzle and a plasma electrode, and a MIG torch including a MIG tip and a welding wire are arranged so as to face in different directions at a predetermined distance from each other,
wherein a plasma arc is made to locally overlap with a tip end portion of the welding wire in order to carry out heating, and in a state in which melting of the welding wire is promoted, MIG welding is carried out without short-circuiting between an object to be welded and a tip end of the welding wire which is a consumable electrode.

2. The plasma-MIG welding method according to claim 1, wherein a tip end portion, which is a part of a projection portion of the welding wire projected from a tip end of a nozzle for a shield gas to be supplied to the MIG torch, is heated.

3. The plasma-MIG welding method according to claim 2, wherein in the projection portion of the welding wire, the tip end portion of a length of 3 to 10 times a diameter of the welding wire is heated.

4. The plasma-MIG welding method according to claim 1, wherein in the state in which melting of the welding wire is promoted, the tip end portion is heated so as to generate a droplet of a diameter of 1 to 2 times a diameter of the welding wire.

5. The plasma-MIG welding method according to claim 2, wherein in the state in which melting of the welding wire is promoted, the tip end portion is heated so as to generate a droplet of a diameter of 1 to 2 times a diameter of the welding wire.

6. The plasma-MIG welding method according to claim 3, wherein in the state in which melting of the welding wire is promoted, the tip end portion is heated so as to generate a droplet of a diameter of 1 to 2 times the diameter of the welding wire.

7. A welding torch of the plasma-MIG welding device which is used in the plasma-MIG welding method according to claim 1,
wherein the plasma torch section including the plasma nozzle and the plasma electrode, and the MIG torch including the MIG tip and the welding wire are arranged so as to face in different directions at the predetermined distance from each other, and
wherein the plasma torch section and the MIG torch are arranged at positions in which the plasma arc can locally overlap with the tip end portion of the welding wire, and a central axis line of the plasma torch section and a central axis line of the MIG torch intersect at an acute angle.
